(19) United States
(12) Patent Application Publication
(10) Pub. No.: US 2014/0117290 A1
(43) Pub. Date: May 1, 2014

(54) EPOXIDISED NATURAL RUBBER-BASED BLEND WITH REVERSIBLE ELECTRICAL BEHAVIOUR

(71) Applicant: Yong Kok Chong, Kuala Lumpur (MY)

(72) Inventor: Yong Kok Chong, Kuala Lumpur (MY)

(73) Assignee: LEMBAGA GETAH MALAYSIA, Kuala Lumpur (MY)

(21) Appl. No.: 14/125,312

(22) PCT Filed: Jun. 8, 2012
(86) PCT No.: PCT/MY2012/000117

§ 371 Date: Dec. 10, 2013

(30) Foreign Application Priority Data
Jun. 10, 2011 (MY) PI2011002656

(51) Int. Cl. C08L 7/00

(52) U.S. Cl. CPC C08L 7/00
USPC 252/507; 252/519.33

(57) ABSTRACT

Epoxidised natural rubber [ENR] based vulcanised-blends with two different types of electrical conductive filler (i.e. conductive grade-carbon black and intrinsically electrical conductive polymer) may be produced respectively by using either internal mechanical mixing method or open milling method or the combination of the two methods. All these ENR based vulcanised-blends show high consistent reversible electrical behaviour under the tensile straining process. They also exhibit useful mechanical property ties with tensile strengths up to 28.0 MPa, elongations at break up to 800.0% and Dunlop rebound resiliencies up to 55.0%. The lower the rebound resilience, the better the damping property and shock absorption ability for the ENR based vulcanised-blends. As a result, these ENR based vulcanised-blends are ideal to be used for manufacturing flexible sensors that may correspond to the tensile straining process.

### TECHNICAL FIELD

The present invention relates to an epoxidised natural rubber (ENR) based vulcanised blend targeted for flexible sensors manufacturing or application and method of preparation of the same.

### BACKGROUND ART

Different types of filler are regularly used to alter the physical behaviours of an elastomer by simply introducing them into the elastomer's matrix. Changes of static and dynamic moduli, strength, abrasion resistance and electrical conductivity are usually expected for the filled elastomer.

Percolation threshold is a volume fraction of conductive filler at which it can be assumed that a continuous interconnecting conductive filler network is created within its elastomeric host matrix. Below this volume fraction, the electrical resistivity is relatively high and above this threshold, the elastomeric compound behaves like an electrical conductor. In the region of the percolation threshold, the conductive filler particles will relocate and also re-orientate under the mode of tensile strain or compression and subsequently result in changes of its electrical behaviour. It is also known that the electrical resistance of an elastomeric compound will decrease as the content of its conductive filler increased.

Therefore, it is possible to design and prepare a type of electrically conductive flexible material by using just the electrically conductive ENR based blend. This type of flexible material can consistently and accurately correspond in term of changing its electrical conductivity (either increase or decrease) during the altering of its physical dimensions via the tensile straining process.

Both natural rubber and synthetic rubber blends based on a common reinforcing grade-carbon black (i.e. N330) exhibited non-reproducible electrical behaviour after only one time of straining process [as reported by K. Yamaguchi et al, Journal of Applied Polymer Science Polymer Physic, 2003]. The conductivities of blends of ethylene-propylene-diene rubber, nitrile rubber and silicone rubber respectively with common reinforcing grade-carbon blacks as conductive fillers were also decreased by increasing the degree of their test pieces compression [as reported by K P. Sau et al, Rubber Chemistry and Technology, 2000]. All these observations were attributed to the permanent destruction of the interconnecting networks as built up by the common reinforcing grade-carbon black particles during their reorientation or relocation process.

U.S. Pat. Nos. 5,010,774, 6,694,820, 6,791,342, 7,303,333 and US patent Pending, Application No. 20100126273 all described the usage of synthetic polymeric based materials (e.g. polyimide substrate) for sensor devices manufacturing. Literature [V. Jha et al, Journal of Applied Polymer Science, 2010] also reported about the successful preparation of non-chemically modified natural rubber based materials (incorporated with a type of specialty conductive grade-carbon black), which displayed reversible electrical behaviour under the process of tensile straining.

### DISCLOSURE OF INVENTION

### Technical Problem

### Solution to Problem

### Summary of the Invention

It is according to one aspect of the present invention to provide an epoxidised natural rubber [ENR] based vulcanised blend for flexible sensors manufacturing or application comprising; epoxidised natural rubber [ENR], electrically conductive fillers and vulcanisation agents.

Vulcanisation accelerators, vulcanisation activators and vulcanisation coagents are selectively added to the ENR based blend in order to accelerate, activate and enhance the blend's vulcanisation process. Antioxidants are selectively added in the hope to enhance the blend'd oxidation resistance. Processing waxes are selectively added in order to enhance the processability of the blend. Dispersing agents are selectively added in order to enhance the dispersion level of electrically conductive fillers. Colouring agents are also selectively added in order to adjust the level of original colour of the ENR based vulcanised-blend.

Accordingly, the present invention introduces ENR based vulcanised-blend as a new material for flexible sensors manufacturing and application. The targeted flexible sensors that are made from this ENR based vulcanised-blend may correspond to the tensile straining process in a consistent and accurate way. ENR is a type of chemically modified natural rubber, which can be obtained by reacting the natural rubber with peroxy formic acid. ENR is also categorised as an environmentally friendly and sustainable material since it is sourced from the Hevea Braziliensis trees. Several advantages [as reported by I. R. Gelling, Journal of Natural Rubber Research, 1991] can be obtained by using ENR based blends, i.e. good dispersion level of fillers, good tensile properties, good oil resistance, improved oxidation resistance, low gas permeability and high abrasion resistance. Apart from all of these, ENR based materials may also exhibit higher damping behaviour (if compared to the non-modified natural rubber), which is an advantage in shock absorption and can reduce unnecessary noises if used for high-accuracy sensors manufacturing.

According to second aspect of the present invention, there is provided an internal mechanical mixing method for preparation of ENR based vulcanised-blends by using internal mechanical mixing device and open milling device. This method comprising the steps of:

(a) adding ENR to an internal mechanical mixing device;

(b) mixing of ENR with electrically conductive filler s by using an internal mechanical mixing device to produce masterbatch;

(c) discharge of the masterbatch, comprising of ENR, electrically conductive filler s, dispersing agents (if added), processing waxes (if added), antioxidants (if added) and vulcanisation activators (if added) from the internal mechanical mixing device;

(d) mixing of masterbatch with vulcanisation agents by using an open milling device to produce blend;

(e) discharging of the blend from the open milling device; and

(f) vulcanisation of the blend by either heating or microwave.

Accordingly, wherein step (b) further comprising the step of adding either vulcanisation activators or antioxidants or dispersing agents or processing waxes or in any combination thereof.

Accordingly, wherein step (d) further comprising the step of adding either vulcanisation accelerators or vulcanisation coagents or colouring agents or in any combination thereof.

According to third aspect of the present invention, there is provided an open milling method for preparation of ENR based vulcanised-blends by using only open milling device. This method comprising the steps of:

(a) adding ENR to an open milling device;

(b) mixing ENR with electrically conductive filler s by using an open milling device to produce masterbatch;

(c) mixing of the masterbatch with vulcanisation agents by using an open milling device to produce blend;

(d) discharge of the blend from the open milling device; and

(e) vulcanisation of the blend by either heating or microwave.

Accordingly, wherein step (b) further comprising the step of adding either vulcanisation activators or antioxidants or dispersing agents or processing waxes or in any combination thereof.

Accordingly, step (c) further comprising the step of adding either vulcanisation accelerators or vulcanisation coagents or colouring agents or in any combination thereof.

The present invention consists of several novel features and a combination of parts hereinafter fully described and illustrated in the accompanying description and drawings, it being understood that various changes in the details may be made without departing from the scope of the invention or sacrificing any of the advantages of the present invention.

### BRIEF DESCRIPTION OF DRAWINGS

The present invention will be fully understood from the detailed description given herein below and the accompanying drawings which are given by way of illustration only, and thus are not limitative of the present invention, wherein:

FIG. 1 illustrates the basic chemical structure of the smallest repeat unit of an epoxidised natural rubber example;

FIG. 2 illustrates the basic chemical structure of the smallest repeat unit of a sulfonic acid doped polyaniline example, i.e. the polyaniline dodecylbenzenesulfonate;

FIG. 3: illustrates exemplary flowchart of the first method of preparation of the epoxidised natural rubber based blend, namely the internal mechanical mixing method.

FIG. 4: illustrates exemplary flowchart of the second method of preparation of the epoxidised natural rubber based blend, namely the open milling method.

FIG. 5: Log Electrical Conductivity versus Length Elongation % for the Sulfur-Vulcanised ENR-Printex XE2B Blends; (a) Blend with 5.0 wt % Printex XE2B, (b) Blend with 10.0 wt % Printex XE2B, (c) Blend with 20.0 wt % Printex XE2B and (d) Blend with 40.0 wt % Printex XE2B.

FIG. 6: Log Electrical Conductivity versus Length Elongation % for the Sulfur-Vulcanised ENR-Pani.DBSA Blends; (a) Blend with 5.0 wt % Pani.DBSA, (b) Blend with 10.0 wt % PAni.DBSA, (c) Blend with 20.0 wt % PAni.DBSA and (d) Blend with 40.0 wt % PAni.DBSA.

### DETAILED DESCRIPTION OF THE PREFERRED EMBODIMENT OF THE PRESENT INVENTION

### Definition

1. Vulcanisation: as used herein the term means a process of crosslinking of a rubber's polymer chains
2. Vulcanisation agent: as used herein the term means any chemicals (for examples, sulfur and peroxide) added to a rubber to create crosslinking reaction of the rubber's polymer chains
3. Vulcanisation accelerator: as used herein the term means any chemicals added to the rubber as catalyst to accelerate vulcanisation reaction
4. Vulcanisation activator: as used herein the term means any chemicals added to the rubber as catalyst to activate vulcanisation reaction
5. Vulcanisation coagent: as used herein the term means any chemicals added to the rubber to enhance its polymer chains crosslinking efficiency and level
6. Vulcanisation system: as used herein the term means a system that comprising of vulcanisation agents, vulcanisation accelerators, vulcanisation activators and vulcanisation coagents

The present invention relates to an ENR based vulcanised-blend with good mechanical properties and reversible electrical behaviour, which also suitable for flexible sensor devices manufacturing and application. Hereinafter, this specification will describe the present invention according to the preferred embodiments of the present invention. However, it is to be understood that limiting the description to the preferred embodiments of the invention is merely to facilitate discussion of the present invention and it is envisioned that those skilled in the art may devise various modifications and equivalents without departing from the scope of the appended claims.

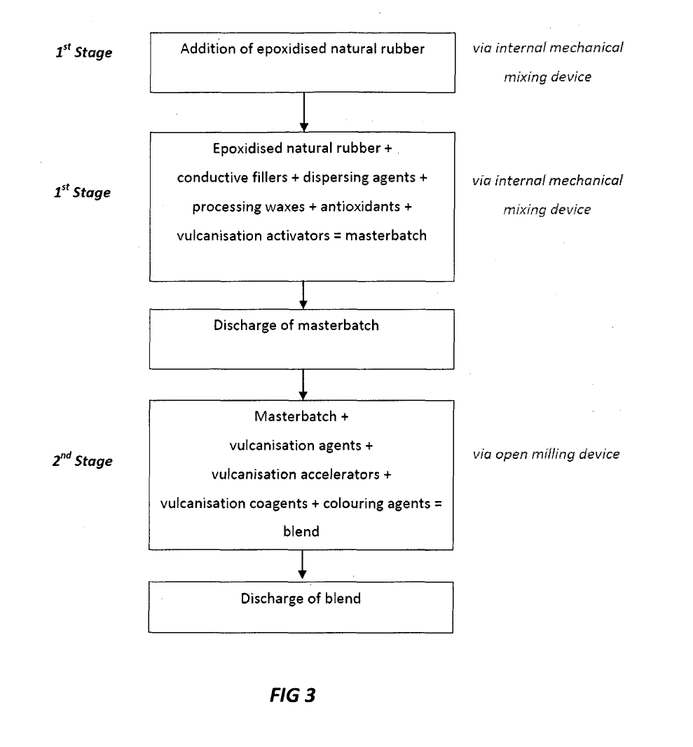

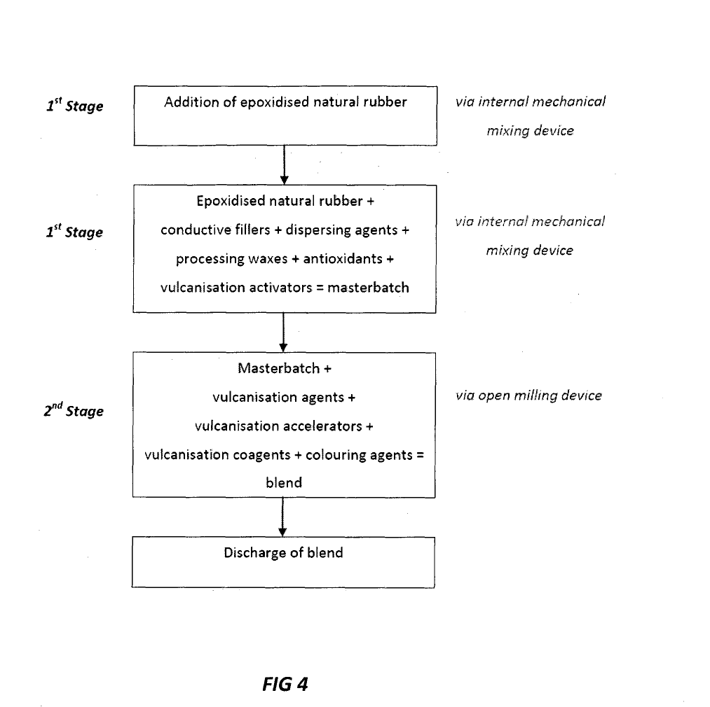

The present invention also describes two practical methods for preparation of the vulcanised electrically conductive ENR based blend targeted for flexible sensors manufacturing and application, i.e. the internal mechanical mixing method and the open milling method. All vulcanised electrically conductive ENR blends in this present invention are based on ENR as the only rubber host and either specialty conductive grade-carbon black or solid intrinsically electrical conductive polymer as the only electrically conductive filler. All these major constituent materials in solid form are known to be highly processable with the help of some common mechanical mixing devices, such as internal mechanical mixing device (refer to FIG. 3) and open milling device (refer to FIG. 4). The level of the original colour of all vulcanised electrically conductive ENR based blends in this present invention is also adjustable with the inclusion of colouring agents.

In view of problems such as material sustainability issue and poor damping properties for all polymeric based materials as used in prior arts, it is now able to demonstrate that the high damping and very low electrical resistance of the vulcanised ENR based blend (up to the order of 10′ ohms in term of electrical resistance) can be prepared directly by using either the internal mechanical mixing method or the open milling method. Both of these preparation methods are commercially friendly due to their practicability and high production rate. Suitable methods for processing and shaping this type of ENR based blend into products are including various types of rubber processing equipment, such as injection moulding, extrusion and hot press-moulding.

Conductive grade-carbon blacks and solid intrinsically electrical conductive polymers (e.g. polyaniline, polypyrrole, polythiophene and etc) are selectively added as the electrical conductive fillers due to the unique features of their particles. Both types of conductive filler do feature particles with higher surface area as a result of their particle shapes (e.g. ‘hollowed out’ shape for specialty conductive grade-carbon blacks and elongated shape for intrinsically electrical conductive polymers). These high surface area-conductive filler particles may undergo relocation and reorientation without losing their inter-connected conductive paths during the tensile straining or compression process. These unique particle features also subsequently contribute to the reversible electrical behaviour under tensile straining process.

Masterbatches with different compositions of ENR, electrically conductive fillers, vulcanisation activators, antioxidants, dispersing agents and processing waxes are prepared by using either an internal mechanical mixing device (at temperature up to 300.0° C., fill factor up to 0.95 and rotors speed up to 200.0 rounds per minute) or by using an open milling device (at temperature up to 300.0° C.) at the first stage of mixing process.

Vulcanisation agents, vulcanisation accelerators, vulcanisation coagents and colouring agents a re added later (during the second stage of mixing process) to each ENR based masterbatch by using an open milling device (at temperature up to 100.0° C.) in order to avoid the premature vulcanisation problem that can cause hardening and reducing the processability of the produced ENR based blend.

The total mixing period to produce ENR based vulcanised-blend by using both types of methods is fallen between 1 to 60 minutes.

All vulcanised (at temperature up to 250° C.) ENR based blends [including 1.0 to 50.0 parts per hundred rubber (p.p.h.r.) of electrically conductive fillers] prepared by using either internal mechanical mixing method or open milling method, exhibit good electrical conductivities (up to the magnitude order of 10⁻¹ S/cm), reversible electrical behaviour and other useful physical properties (i.e. tensile strengths up to 28.0 MPa, elongations at break up to 800.0%, Shore A hardness up to 95.0, compression sets up to 60.0% and Dunlop rebound resiliencies up to 55.0%).

Mixing proportions and function of each of the raw materials, chemicals and processing devices used to produce the electrical conductive vulcanised ENR based blends with reversible electrical behaviour are listed as following:

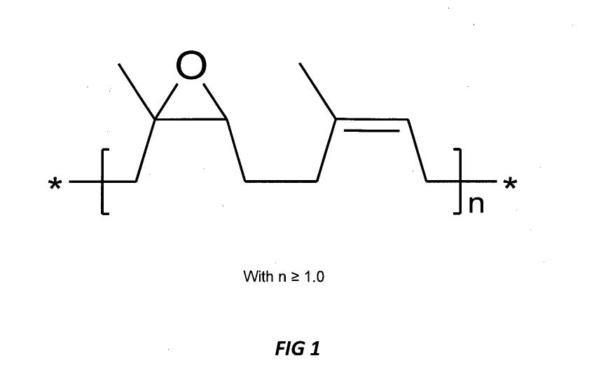

From hereinbelow, the preferred embodiments of the present invention will be discussed in relation to the accompanying FIGS. 1 to 4, which will be used independently or in any combination thereof.

50.0 to 99.0 p.p.h.r. of solid ENR (refer to FIG. 1) with any grades up to 75.0 mole % of epoxide contents, are used as the solid rubber host.

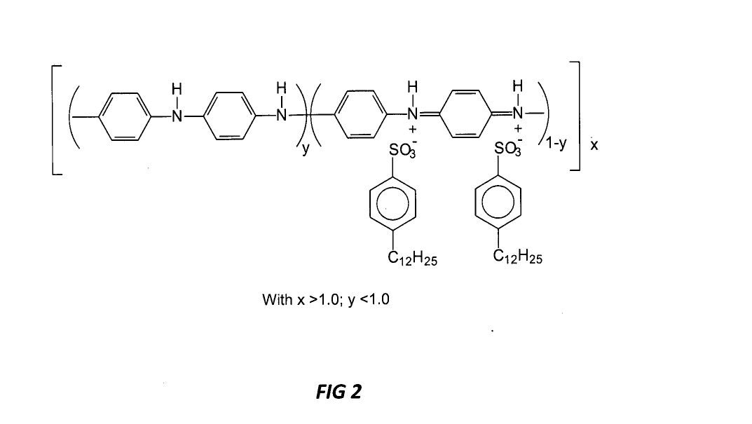

1.0 to 50.0 p.p.h.r. of electrically conductive fillers (include types of either conductive grade-carbon black or solid intrinsically electrical conductive polymer) are used. Example of molecular structure of solid intrinsically electrical conductive polymer (i.e. polyaniline dedecylbenzenesulfonate) is shown in FIG. 2.

0.1 to 10.0 p.p.h.r. of vulcanisation agents (either sulfur or peroxide type), 0 to 10.0 p.p.h.r. of vulcanisation accelerators, 0 to 12.5 p.p.h.r. of vulcanisation activators and 0 to 20.0 p.p.h.r. of vulcanisation coagents are used as the ingredients for all ENR based blends vulcanisation purpose.

0 to 20.0 p.p.h.r. of antioxidants (either staining or non-staining grades, may be used independently or in any combination thereof) are included into all ENR based blends in the hope to enhance their oxidation resistance.

0 to 20.0 p.p.h.r. of processing waxes (include types of either natural or synthetic wax, may be used independently or in any combination thereof) are included into all ENR based blends as processing aid in order to enhance the processability of the ENR based blend.

0 to 100.0 p.p.h.r. of dispersing agents are included into all ENR based blends in order to enhance the dispersion level of electrically conductive fillers.

0 to 35.0 p.p.h.r. of colouring agents (either in solid or liquid form) are included into all ENR based blends in order to adjust the level of original colour of the ENR based blend.

Internal mechanical mixing device (refer to FIG. 3) is a general rubber or polymer processing device, which includes of some main structures in a closed system, i.e. a controllable moving (up and down movements) ram, a pair of rotating rotors (with controllable rotating speed) and equipped with a heating system in order to control the mixing chamber's temperature. Size of the device is varied and depends on the amount of material that is processed.

Open milling device (refer to FIG. 4) is a general rubber processing device, which includes of main structures, i.e. a pair of counter-rotating rollers in an open system and is equipped with a heating system in order to control the rollers surfaces temperature. Size of the device is varied and depends on the amount of material that is processed.

Both open milling device and internal mechanical mixing device may be used independently or in any combination thereof.

The invention now being generally described, the same will be better understood by reference to the following detailed examples which are provided for purposes of illustration only and are not to be limiting of the invention unless so specified.

### Example 1

### Formulation of Sulfur-Vulcanised Epoxidised Natural Rubber [ENR] Based Blend with Reversible Electrical Behaviour

Sulfur-vulcanised ENR based blends with various compositions of electrical conductive filler are prepared in order to study their important physical properties and also electrical conductivity behaviour. Selected examples of formulation for preparing the vulcanised ENR based blends are shown in Table 1.

TABLE 1
Formulations of Electrically Conductive Sulfur-Vulcanised ENR based Blends

| Raw material/ | Part per hundred rubber [p.p.h.r.] | | | | | | | |
|---|---|---|---|---|---|---|---|---|
| Chemical | Blend 1 | Blend 2 | Blend 3 | Blend 4 | Blend 5 | Blend 6 | Blend 7 | Blend 8 |
| ENR 50 | 95.0 | 90.0 | 80.0 | 60.0 | 95.0 | 90.0 | 80.0 | 60.0 |
| Printex XE2B | 5.0 | 10.0 | 20.0 | 40.0 | — | — | — | — |
| PAni.D BSA | — | — | — | — | 5.0 | 10.0 | 20.0 | 40.0 |
| Paraffin wax | 0.5 | 0.5 | 0.5 | 0.5 | — | — | — | — |
| Dispersing agent | — | — | — | — | 5.0 | 10.0 | 20.0 | 40.0 |
| Titanium dioxide | 5.0 | 5.0 | 5.0 | 5.0 | 5.0 | 5.0 | 5.0 | 5.0 |
| Permanax WSL | 1.0 | 1.0 | 1.0 | 1.0 | 1.0 | 1.0 | 1.0 | 1.0 |
| Santocure NS | 1.6 | 1.6 | 1.6 | 1.6 | 1.6 | 1.6 | 1.6 | 1.6 |
| Zinc oxide | 5.0 | 5.0 | 5.0 | 5.0 | 5.0 | 5.0 | 5.0 | 5.0 |
| Stearic acid | 2.5 | 2.5 | 2.5 | 2.5 | 2.5 | 2.5 | 2.5 | 2.5 |
| Sulfur | 2.0 | 2.0 | 2.0 | 2.0 | 2.0 | 2.0 | 2.0 | 2.0 |

Solid epoxidised natural rubber (i.e. ENR 50 grade with 48.0±3.0 mole % of epoxide contents, manufactured by the Malaysian Rubber Board) is used as the favourable rubber host.

5.0 to 40.0 p.p.h.r. of Printex XE2B (manufactured by Evonik Degussa GmbH) is chosen as the favourable type of conductive grade-carbon black.

5.0 to 40.0 p.p.h.r. of solid polyaniline dodecylbenzenesulfonate [PAni.DBSA] (synthesised in house by using oxidation polymerisation method, with protonation level 48.0±2.0%) is used as the favourable type of intrinsically electrical conductive polymer.

2.0 p.p.h.r. of sulfurs are used as the vulcanising agent and 1.6 p.p.h.r. of Santocure NS (N-t-butyl-2-benzothiazole sulfenamide) as the favourable vulcanisation system's accelerators. Both 5.0 p.p.h.r. of zinc oxide and 2.5 p.p.h.r. of stearic acid are added as the vulcanisation system's activators.

1.0 p.p.h.r. of Permanax WSL (alpha-1-methyl cyclohexyl derivative of selected xylenols) is added as the antioxidant (a non-staining grade).

5.0 p.p.h.r. of titanium dioxides are added as the white-colouring agent. The titanium dioxides used are in solid powder form.

For ENR-Printex XE2B blend, 0.5 p.p.h.r. of paraffin wax is used as the processing aid in order to enhance the processability of the blend.

For ENR-PAni.DBSA blend, a special formulated dispersing agent (includes premixing of 80.0 weight % of zinc oxide and 20.0 weight % of dopant, i.e. benzenesulfonic acid) is included here. The premixing is prepared by using a mechanical mixing device at temperature 230° C.

### Example 2

### Preparation of Sulfur-Vulcanisation System Containing Epoxidised Natural Rubber [ENR] Based Blends by Using the Internal Mechanical Mixing Method

For the first stage of mixing, ENR based masterbatches with different proportions [in p.p.h.r.] of electrical conductive fillers (accordingly to the formulation as shown in Table 1 of Example 1) are prepared by using an internal mechanical mixing method as illustrated by FIG. 3. A fill factor of 0.70 (from the total free volume of an internal mixing device's mixing chamber) is used to perform all mixings. For ENR-Printex XE2B blends, the starting temperature for each mixing is 70° C. For ENR-PAni.DBSA blends, the starting temperature for each mixing is 120° C. The rotor speed is 100 rounds per minute for both types of blend. Stages of each mixing are described in Table 2:

TABLE 2
Stages of Preparation of ENR based Masterbatch by using
the Internal Mechanical Mixing Method

| Stage of mixing | Timing |
|---|---|
| 1. Addition of ENR | 0^{th} minute |
| 2. Addition of electrically conductive | 2^{nd} minute |
| filler, dispersing agent, processing wax, | |
| antioxidant and activators to produce | |
| masterbatch | |
| 3. Discharge of masterbatch | 6^{th} minute |
| | (Total time = 6 minutes) |

For the second stage of mixing, 2.0 p.p.h.r. of sulfurs, 1.6 p.p.h.r. of Santocure NS and 5.0 p.p.h.r. of titanium dioxides are added to each of the ENR based masterbatches on a two-roll open milling device (at temperature 50° C., with the nip's gap distance is adjusted to 2±0.2 mm). Each of the produced sulfur-vulcanisation system containing ENR based blend is then removed from the two-roll open milling device after 6 minutes of total mixing period.

### Example 3

### Preparation of Sulfur-Vulcanised Epoxidised Natural Rubber [ENR] Based Blends with Reversible Electrical Conductivity

Each of the sulfur-vulcanisation system containing ENR based blends is prepared accordingly to Examples 1 and 2. Appropriate amounts (varied according to the type of targeted testing) of each of the sulfur-vulcanisation system containing ENR based blends are cut and fed into a mould (dimension of the mould is also varied according to the type of targeted testing). The mould together with the sulfur-vulcanisation system containing ENR based blend are sent for vulcanisation by using an electrical hot press machine with heating temperature 150° C., pressure 60 psi and duration based on the T_{c90} (curing time to at least 90% of curing level) of each blend (as measured by a Monsanto's moving die-rheometer). The T_{c90} values of blends prepared by using internal mechanical mixing method are reported in Table 3.

TABLE 3
T_{c90} of Sulfur-Vulcanisation System Containing
ENR based Blends (Cured at Temperature, 150° C.)

| ENR based Blend | T_{c90} (minute) |
|---|---|
| Blend 1 | 6.10 |
| Blend 2 | 5.50 |
| Blend 3 | 5.05 |
| Blend 4 | 4.25 |
| Blend 5 | 6.52 |
| Blend 6 | 5.98 |
| Blend 7 | 5.45 |
| Blend 8 | 4.98 |

### Example 4

### Electrical and Physical Properties of the Sulfur-Vulcanised Epoxidised Natural Rubber [ENR] Based Blends

Unstrained test pieces of sulfur-vulcanised ENR based blends prepared accordingly to Examples 1-3 showed electrical conductivities (calculated based on the volume resistances as measured using 2-probe technique with a Keithley 6157A Electrometer) up to the magnitude order of 10⁻¹ S/cm (refer to Table 4).

TABLE 4
Orders of electrical conductivity value (S/cm) for
Unstrained Test Pieces of Sulfur-Vulcanised ENR
based Blends prepared accordingly to Examples 1-3

| ENR-Carbon | Order of Electrical Conductivity |
|---|---|
| Black Blend | Value (S/cm) |
| Blend 1 | ×10⁻⁷ |
| Blend 2 | ×10⁻¹ |
| Blend 3 | ×10⁻¹ |
| Blend 4 | ×10⁻¹ |
| Blend 5 | ×10⁻¹⁰ |
| Blend 6 | ×10⁻³ |
| Blend 7 | ×10⁻¹ |
| Blend 8 | ×10⁻¹ |

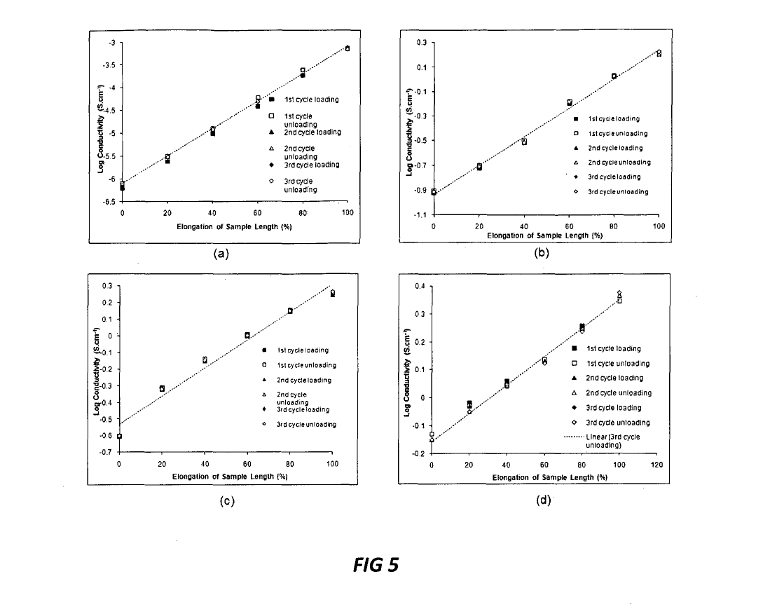

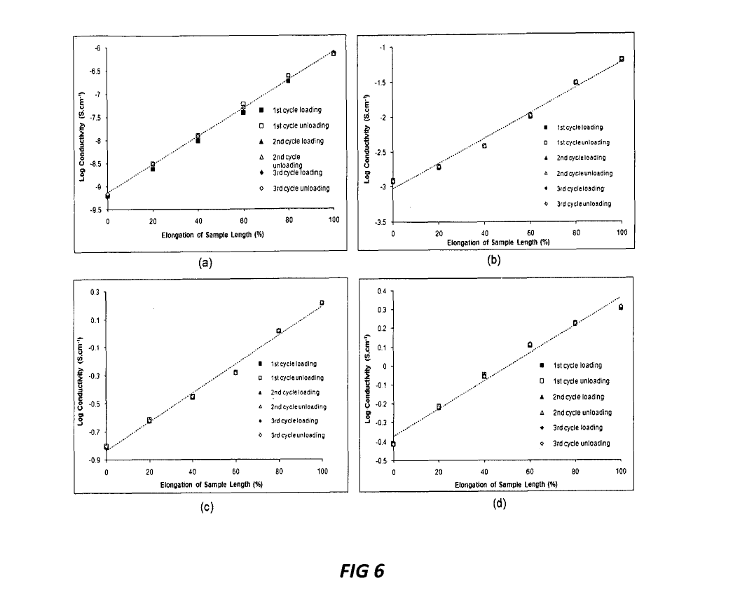

The effect of tensile straining (up to 100.0% elongation in term of sample's length) on all sulfur-vulcanised ENR based blends (as shown in Table 1) was also investigated. A Keithley 6517A electrometer was again used for this testing. For each blend, six test pieces (in strip form with dimensions 80 mm×20 mm×1 mm) were prepared using a hot press (150° C. and duration according to Table 3) in order to obtain a mean value. Each of the test pieces was strained by using an in house designed jig system. Three separated cycles of tensile straining process (with each cycle consisted 300 times of strain loading and unloading process) were carried out for the selected blends and the mean electrical conductivity value obtained from each cycle was calculated respectively. Results of some representative examples are as shown in FIGS. 5 and 6.

The first, second and third cycles of tensile straining process for all sulfur-vulcanised ENR based blends exhibited similar reversible electrical behaviour, i.e. the electrical conductivities increased or decreased linearly with strain loading or unloading process and also able to recover very closely to the original strained values (i.e. at least 95% similarity) during the strain unloading process. At each straining cycle, the mean conductivity value increased at least by 1 order of magnitude at an elongation of 100% (in term of sample's length). This type of reversible electrical behaviour does render the ENR based vulcanised-blends suitable as a new class of material for flexible sensors manufacturing and application.

Sulfur-vulcanised ENR based blends prepared accordingly to Examples 1-3 exhibited hardness (Shore A) values as shown in Table 5.

TABLE 5
Hardness (Shore A) Values of Sulfur-Vulcanised ENR
based Blends prepared accordingly to Examples 1-3

| ENR-based Blend | Hardness (Shore A) |
|---|---|
| Blend 1 | 41 ± 1 |
| Blend 2 | 53 ± 1 |
| Blend 3 | 58 ± 1 |
| Blend 4 | 71 ± 1 |
| Blend 5 | 42 ± 1 |
| Blend 6 | 55 ± 1 |
| Blend 7 | 60 ± 1 |
| Blend 8 | 78 ± 1 |

Sulfur-vulcanised ENR based blends prepared accordingly to Examples 1-3 showed some main non-aged tensile properties (measured according to the standard, i.e. ISO 37) as summarised in Table 6.

TABLE 6
Non-Aged Tensile Properties of Sulfur-Vulcanised ENR
based Blends prepared accordingly to Examples 1-3

| ENR based Blend | Tensile Strength (MPa) | Elongation at Break (%) |
|---|---|---|
| Blend 1 | 17.5 ± 0.5 | 416.3 ± 20.0 |
| Blend 2 | 22.1 ± 0.5 | 553.5 ± 20.0 |
| Blend 3 | 24.8 ± 0.5 | 647.7 ± 20.0 |
| Blend 4 | 20.5 ± 0.5 | 507.5 ± 20.0 |
| Blend 5 | 13.5 ± 0.5 | 386.0 ± 20.0 |
| Blend 6 | 20.1 ± 0.5 | 460.5 ± 20.0 |
| Blend 7 | 21.8 ± 0.5 | 535.8 ± 20.0 |
| Blend 8 | 20.5 ± 0.5 | 507.4 ± 20.0 |

Sulfur-vulcanised ENR based blends prepared accordingly to Examples 1-3 also showed compression set values (measured according to Standard ISO 815 at 30 min) as reported in Table 7.

TABLE 7
Compression Set Values of Sulfur-Vulcanised ENR
based Blends prepared accordingly to Examples 1-3

| ENR-Carbon Black Blend | Compression Set (%) |
|---|---|
| Blend 1 | 16.5 ± 1.0 |
| Blend 2 | 23.5 ± 1.0 |
| Blend 3 | 27.8 ± 1.0 |
| Blend 4 | 30.0 ± 1.0 |
| Blend 5 | 18.6 ± 1.0 |
| Blend 6 | 24.5 ± 1.0 |
| Blend 7 | 28.3 ± 1.0 |
| Blend 8 | 32.5 ± 1.0 |

Sulfur-vulcanised ENR based blends prepared accordingly to Examples 1-3 exhibited Dunlop rebound resilience values (measured according to Standard BS 903 Part A8) as reported in Table 8. Damping property of the ENR based blend always enhanced with its decreasing Dunlop rebound resilience value.

TABLE 8
Dunlop Rebound Resilience Values of Sulfur-Vulcanised
ENR based Blends prepared accordingly to Examples 1-3

| ENR-Carbon | Dunlop Rebound |
|---|---|
| Black Blend | Resilience (%) |
| Blend 1 | 47.0 ± 0.5 |
| Blend 2 | 44.0 ± 0.5 |
| Blend 3 | 42.0 ± 0.5 |
| Blend 4 | 28.0 ± 0.5 |
| Blend 5 | 45.0 ± 0.5 |
| Blend 6 | 41.0 ± 0.5 |
| Blend 7 | 39.0 ± 0.5 |
| Blend 8 | 27.0 ± 0.5 |

The invention being thus described, it will be apparent that the same may be varied in many ways. Such variations are to be regarded as within the scope of the invention, and all such modifications as would be apparent to one skilled in the art are intended to be within the scope of the following claims.

### BEST MODE FOR CARRYING OUT THE INVENTION

### Mode for the Invention

### Industrial Applicability

### Sequence Listing Free Text

1. An epoxidised natural rubber (ENR)] based vulcanised blend for flexible sensor manufacturing or application comprising; ENR, electrically conductive fillers and vulcanisation agents.

2. The ENR based blend according to claim 1, wherein the blend composition ranges from;
50.0 to 99.0 p.p.h.r. of ENR;
1.0 to 50.0 p.p.h.r. of electrically conductive fillers;
0.1 to 10.0 p.p.h.r. of vulcanisation agent with a purity level up to 100.0 wt %.

3. The ENR based blend according to claim 1, wherein the blend selectively comprising:
0 to 10.0 p.p.h.r. of vulcanisation accelerators with a purity level up to 100.0 wt %;
0 to 12.5 p.p.h.r. of vulcanisation activators with a purity level up to 100.0 wt %;
0 to 20.0 p.p.h.r. of vulcanisation coagents with a purity level up to 100.0 wt %;
0 to 20.0 p.p.h.r. of antioxidants with a purity level up to 100.0 wt %;
0 to 20.0 p.p.h.r. of processing waxes;
0 to 100.0 p.p.h.r. of dispersing agents; and
0 to 35.0 p.p.h.r. of colouring agents with a purity level up to 100.0 wt %.

4. The ENR based blend according to claim 1, wherein the blend selectively comprising vulcanisation accelerators, vulcanisation activators and vulcanisation coagents in order to accelerate, activate and enhance the ENR based blend's vulcanisation process.

5. The ENR based blend according to claim 1, wherein the blend further selectively comprising colouring agents in order to adjust the level of original colour of ENR based blend.

6. The ENR based blend according to claim 5, wherein the colouring agents include forms of either solid or liquid or in any combination thereof.

7. The ENR based blend according to claim 1, wherein the vulcanisation agents are selected from either sulfur or peroxide.

8. The ENR based blend according to claim 1, wherein the ENR further comprising any solid grades up to 75.0 mole % of epoxide contents.

9. The ENR based blend according to claim 1, wherein the electrically conductive fillers are selected from either conductive grade-carbon black or solid intrinsically electrical conductive polymer.

10. The ENR based blend according to claim 1, wherein the antioxidants are selected from either staining or non-staining grades or in any combination thereof.

11. The ENR based blend according to claim 1, wherein the vulcanisation activators are selected from either combination of metallic oxide and stearic acid or the direct form of metallic stearate.

12. The ENR based blend according to claim 1, wherein the vulcanisation accelerators are selected from type of either guanidine or sulphenamide or thiazole or thiuram or dithiocarbamate or xanthate or in any combination thereof.

13. The ENR based blend according to claim 1, wherein the vulcanisation coagents are selected from the groups of either dimaleimide or trimethecrylate or isocyanate or in any combination thereof.

14. The ENR based blend according to claim 1, wherein the processing waxes claimed are selected from types of either natural or synthetic wax or in any combination thereof.

15. The ENR based blend according to claim 1, wherein the dispersing agents include premixing of up to 90.0 weight % of zinc oxide and up to 50.0 weight % of dopant, i.e. sulfonic acid.

16. The ENR based blend according to claim 1, wherein the premixing of dispersing agents are prepared by using any type of mechanical mixing device.

17. The ENR based blend according to claim 1, wherein the premixing of dispersing agents are prepared by heating at temperature up to 300° C.

18. The ENR based blend according to claim 1, wherein the blend exhibits electrical conductivity values up to the magnitude order of 10-1 S/cm, tensile strengths up to 28.0 MPa, elongations at break up to 800.0%, hardness equal of Shore A up to 95.0, compression sets up to 60.0% and Dunlop rebound resiliencies up to 55.0%.

19. The method for preparation of ENR based blend according to claim 1, comprising the steps of:
(a) adding ENR to an internal mechanical mixing device;
(b) mixing of ENR with electrically conductive fillers by using an internal mechanical mixing device to produce masterbatch;
(c) discharge of the masterbatch from the internal mechanical mixing device;
(d) mixing of masterbatch with vulcanisation agents by using an open milling device to produce blend;
(e) discharging the blend from the open milling device; and
(f) vulcanisation of the blend by heating or microwave.

20. The method according to claim 19, wherein step (b) further comprising the step of adding vulcanisation activators or dispersing agents or processing waxes or antioxidants or in any combination thereof.

21. The method according to claim 19, wherein step (d) further comprising the step of adding either vulcanisation accelerators or vulcanisation coagents or colouring agents or in any combination thereof.

22. The method for preparation of ENR based blend according to claim 1, comprising the steps of:
(a) adding ENR to an open milling device;
(b) mixing ENR with electrically conductive filler s by using an open milling device to produce masterbatch;
(c) mixing of the masterbatch with vulcanisation agents by using an open milling device to produce blend;
(d) discharge of the Mend from the open milling device; and
(e) vulcanisation of the blend by either heating or microwave.

23. The method according to claim 22, wherein step (b) further comprising the step of adding vulcanisation activators or dispersing agents or processing waxes or antioxidants or in any combination thereof.

24. The method according to claim 22, wherein step (c) further comprising the step of adding either vulcanisation accelerators or vulcanisation coagents or colouring agents or in any combination thereof.

25. The method according to claim 19, wherein the vulcanisation process of all ENR based blends are performed at temperature ranges up to 300.0° C. by either heating or microwave.

26. The ENR based blend according to claim 1, wherein the ENR based blend is usable in the preparation of flexible sensor, wherein the flexible sensor corresponds in term of changing its electrical conductivity during the altering of its physical dimensions via tensile straining process.

27. The ENR based blend according to claim 26, wherein the changing of electrical conductivity of the flexible sensor is either in electrical conductivity increment or decrement.

28. The ENR based blend according to claim 26, wherein the alternation of physical dimensions include either the sensor's width or length or thickness or in any combination thereof.

29. The ENR based blend according to claim 2, wherein the blend selectively comprising vulcanisation accelerators, vulcanisation activators and vulcanisation coagents in order to accelerate, activate and enhance the ENR based blend's vulcanisation process.

30. The ENR based blend according to claim 3, wherein the blend selectively comprising vulcanisation accelerators, vulcanisation activators and vulcanisation coagents in order to accelerate, activate and enhance the ENR based blend's vulcanisation process.

31. The ENR based blend according to claim 2, wherein the blend further selectively comprising colouring agents in order to adjust the level of original colour of ENR based blend.

32. The ENR based blend according to claim 31, wherein the colouring agents include forms of either solid or liquid or in any combination thereof.

33. The ENR based blend according to claim 3, wherein the blend further selectively comprising colouring agents in order to adjust the level of original colour of ENR based blend.

34. The ENR based blend according to claim 33, wherein the colouring agents include forms of either solid or liquid or in any combination thereof.

35. The ENR based blend according to claim 2, wherein the vulcanisation agents are selected from either sulfur or peroxide.

36. The ENR based blend according to claim 2, wherein the ENR further comprising any solid grades up to 75.0 mole % of epoxide contents.

37. The ENR based blend according to claim 2, wherein the electrically conductive fillers are selected from either conductive grade-carbon black or solid intrinsically electrical conductive polymer.

38. The ENR based blend according to claim 3, wherein the antioxidants are selected from either staining or non-staining grades or in any combination thereof.

39. The ENR based blend according to claim 3, wherein the vulcanisation activators are selected from either combination of metallic oxide and stearic acid or the direct form of metallic stearate.

40. The ENR based blend according to claim 3, wherein the vulcanisation accelerators are selected from type of either guanidine or sulphenamide or thiazole or thiuram or dithiocarbamate or xanthate or in any combination thereof.

41. The ENR based blend according to claim 3, wherein the vulcanisation coagents are selected from the groups of either dimaleimide or trimethecrylate or isocyanate or in any combination thereof.

42. The ENR based blend according to claim 3, wherein the processing waxes claimed are selected from types of either natural or synthetic wax or in any combination thereof.

43. The ENR based blend according to claim 3, wherein the dispersing agents include premixing of up to 90.0 weight % of zinc oxide and up to 50.0 weight % of dopant, i.e. sulfonic acid.

44. The ENR based blend according to claim 3, wherein the premixing of dispersing agents are prepared by using any type of mechanical mixing device.

45. The ENR based blend according to claim 3, wherein the premixing of dispersing agents are prepared by heating at temperature up to 300° C.

46. The method for preparation of ENR based blend according to claim 2, comprising the steps of:
(a) adding ENR to an internal mechanical mixing device;
(b) mixing of ENR with electrically conductive fillers by using an internal mechanical mixing device to produce masterbatch;
(c) discharge of the masterbatch from the internal mechanical mixing device;
(d) mixing of masterbatch with vulcanisation agents by using an open milling device to produce blend;
(e) discharging the blend from the open milling device; and
(f) vulcanisation of the blend by heating or microwave.

47. The method according to claim 46, wherein step (b) further comprising the step of adding vulcanisation activators or dispersing agents or processing waxes or antioxidants or in any combination thereof.

48. The method according to claim 46, wherein step (d) further comprising the step of adding either vulcanisation accelerators or vulcanisation coagents or colouring agents or in any combination thereof.

49. The method according to claim 46, wherein the vulcanisation process of all ENR based blends are performed at temperature ranges up to 300.0° C. by either heating or microwave.

50. The method for preparation of ENR based blend according to claim 3, comprising the steps of:
(a) adding ENR to an internal mechanical mixing device;
(b) mixing of ENR with electrically conductive fillers by using an internal mechanical mixing device to produce masterbatch;
(c) discharge of the masterbatch from the internal mechanical mixing device;
(d) mixing of masterbatch with vulcanisation agents by using an open milling device to produce blend;
(e) discharging the blend from the open milling device; and
(f) vulcanisation of the blend by heating or microwave.

51. The method according to claim 50, wherein step (b) further comprising the step of adding vulcanisation activators or dispersing agents or processing waxes or antioxidants or in any combination thereof.

52. The method according to claim 50, wherein step (d) further comprising the step of adding either vulcanisation accelerators or vulcanisation coagents or colouring agents or in any combination thereof.

53. The method according to claim 50, wherein the vulcanisation process of all ENR based blends are performed at temperature ranges up to 300.0° C. by either heating or microwave.

54. The method for preparation of ENR based blend according to claim 2 comprising the steps of:
(a) adding ENR to an open milling device;
(b) mixing ENR with electrically conductive filler s by using an open milling device to produce masterbatch;
(c) mixing of the masterbatch with vulcanisation agents by using an open milling device to produce blend;
(d) discharge of the Mend from the open milling device; and
(e) vulcanisation of the blend by either heating or microwave.

55. The method according to claim 54, wherein step (b) further comprising the step of adding vulcanisation activators or dispersing agents or processing waxes or antioxidants or in any combination thereof.

56. The method according to claim 54, wherein step (c) further comprising the step of adding either vulcanisation accelerators or vulcanisation coagents or colouring agents or in any combination thereof.

57. The method according to claim 54, wherein the vulcanisation process of all ENR based blends are performed at temperature ranges up to 300.0° C. by either heating or microwave.

58. The method for preparation of ENR based blend according to claim 3 comprising the steps of:
(a) adding ENR to an open milling device;
(b) mixing ENR with electrically conductive filler s by using an open milling device to produce masterbatch;
(c) mixing of the masterbatch with vulcanisation agents by using an open milling device to produce blend;
(d) discharge of the Mend from the open milling device; and
(e) vulcanisation of the blend by either heating or microwave.

59. The method according to claim 58, wherein step (b) further comprising the step of adding vulcanisation activators or dispersing agents or processing waxes or antioxidants or in any combination thereof.

60. The method according to claim 58, wherein step (c) further comprising the step of adding either vulcanisation accelerators or vulcanisation coagents or colouring agents or in any combination thereof.

61. The method according to claim 58, wherein the vulcanisation process of all ENR based blends are performed at temperature ranges up to 300.0° C. by either heating or microwave.

62. The method according to claim 22, wherein the vulcanisation process of all ENR based blends are performed at temperature ranges up to 300.0° C. by either heating or microwave.
